(19) United States
(12) Patent Application Publication
(10) Pub. No.: US 2026/0210180 A1
(43) Pub. Date: Jul. 23, 2026

(54) STEPLADDER SPREADER BAR TOOL HOLDER

(71) Applicant: Tricam Industries, LLC, Eden Prairie, MN (US)

(72) Inventors: Joseph P. Foley, Mendota Heights, MN (US); Marie A. Vanderwarn, Minneapolis, MN (US)

(73) Assignee: Tricam Industries, LLC, Eden Prairie, MN (US)

(21) Appl. No.: 19/567,476

(22) Filed: Mar. 16, 2026

Related U.S. Application Data
(63) Continuation-in-part of application No. 19/244,306, filed on Jun. 20, 2025.
(60) Provisional application No. 63/662,816, filed on Jun. 21, 2024.

(51) Int. Cl. E06C 1/20; E06C 7/14

(52) U.S. Cl. CPC E06C 1/20; E06C 7/14

(57) ABSTRACT

A spreader bar mechanism for a stepladder is disclosed. More specifically, an improved spreader mechanism that has a spreader bar with a tool holder that increases places on the stepladder where tools or other items while using the stepladder. The disclosed tool holder provides a combination handle and tool holder.

### CROSS-REFERENCE TO RELATED APPLICATIONS

This application is a continuation-in-part of U.S. patent application Ser. No. 19/244,306, filed Jun. 20, 2025, which claims the benefit of U.S. Provisional Application No. 63/662,816, filed Jun. 21, 2024, both of which are hereby incorporated herein in their entirety by reference.

### FIELD OF THE INVENTION

The present disclosure relates generally to step ladders, and more particularly to a stepladder with carrying and lift handles, recessed rail faces, and a single-handed spreader bar with handle for opening and closing the stepladder.

### BACKGROUND OF THE INVENTION

Portable ladders are commonly used for a variety of applications, with several different styles being widely used. The two best known designs are extension ladders, which must be leaned against a vertical surface for support, and A-frame or stepladders, which are free standing. Stepladders have been known for centuries (see, e.g., Miller, U.S. Pat. No. 376,102). Improvements to stepladders have occurred on a regular basis to improve performance, safety, performance, and convenience.

One area of improvement has been the spreader bars used to open and close the front and rear sets of rails. Some early stepladders, such as that taught by Luca, U.S. Pat. No. 2,316,939 didn't use spreaders. Others, for example, Butcher, U.S. Pat. No. 1,224,599 used a rod with hook to engage an eye ring to prevent the pairs of rails from spreading. U.S. Pat. No. 2,521,114 to Campbell, combined a lock with the spreader for moveable ladders. Huss, U.S. Pat. No. 6,116,379 incorporated a third, cross spreader to add stability to an opened stepladder. One example of a spreader mechanism is found in Moss, et al., U.S. Pat. No. 8,186,481, which is related to spreader cross bracing with an orthogonal-to-rung orientation. A recent example of a spreader mechanism is Dickman, U.S. Pat. No. 11,492,850, which discloses spreaders that slide along the rear rails to open and close the ladder. Another example of spreader improvements is the incorporation of a platform with the spreader such as disclosed by U.S. Patent Publication No. 2023/0272670, Foley et al. While these disclosures provided improvements to stepladders, there are still issues with spreader ergonomics and safety that can be addressed.

Another area of improvement for stepladders has been handles and devices to aid in the transporting of folded ladders as well as moving a ladder that is in an upright and open position. One example of a ladder transport design is disclosed by Bush et al., U.S. Pat. No. 5,511,285, which discloses a handle assembly that attaches to the inside rails of a stepladder that allows an elongated handle grip to be external to the rails. Horneman, U.S. Pat. No. 6,786,371 teaches a ladder carrying device of plastic foam blocks mounted to the rails and rungs of a ladder to provide cushion to a carrier's shoulder. U.S. Pat. No. 8,322,491 to Crampton discloses a stepladder with a pad installed within a ladder leg that extends internally past the leg depth to provide cushion for a ladder carrier. A recent example of a ladder carrying device is a semi-cylindrical tubular component with a grip supported by tension only that is installed inside the rail or leg channel. U.S. Patent Publication No. 2018/0163470 teaches the use of plastic inserts within rectangular holes on the rails of stepladders to provide a handhold for climbing a ladder. While these examples provide improvements to stepladders, there are still issues with comfort and efficiency of moving stepladders while open and in-use or closed and being transported.

Stepladders have also seen improvements related to the design of rails to improve strength, weight, and manufacturing efficiency. Early stepladders were typically made of wood and improvement included using wires to add strength to rails (see, e.g., U.S. Pat. No. 146,029 to Smith) and adding bracing between rails and steps to add strength (see, e.g., U.S. Patent No. 538,531 to Miller). Rail improvements also included materials of construction such as metal (see, e.g., U.S. Pat. No. 3,621,936 to Andreassen); fiberglass (see, U.S. Pat. No. 3,042,140 to Basile et al.), and carbon fiber (see Allred, III et al., U.S. Pat. No. 8,800,718). Another method of improving ladder rails includes the method of manufacturing such as disclosed by Moss, U.S. Pat. No. 7,086,499, which discloses a combination of an interior rail with an exterior rail as well as using variations in cross-section of rails. Another method of manufacturing a composite material ladder is disclosed by Ashton et al., U.S. Pat. No. 4,371,055). Another means of improving ladder rails is by modifying the cross-sectional shape of the rail to provide sough-after characteristics. European U.S. Pat. No. 3,604,730 to Mora et al. teaches various profiles of base rail and fly rails. U.S. Pat. No. 11,851,949 to Lentine, et al. discloses a ladder rail profile to provide a more comfortable grip and allow room for internal reinforcement of the rails. A recent example of a rail profile is presented by Foley et al., U.S. Pat. No. D855,833. However, there is a need for a stronger, lighter, and more comfortable ladder rail.

### SUMMARY OF THE INVENTION

Embodiments of the present disclosure provide an improved stepladder spreading mechanism, means for moving a closed and open ladder, and improved rail design.

In one embodiment a front frame and a rear frame are connected by a top cap wherein at least one frame is pivotable on the top cap to allow the ladder to be in a folded, closed orientation and to allow the ladder to be in an open, use orientation. Each frame is comprised of rails connected by steps, rungs, or crossbars running orthogonal to the rails. The front frame and rear frame are further connected by a spreader mechanism pivotally connected to each of the four rails. The spreader mechanism consists of a generally U-shaped spreader bar with a spreader member pivotally connected on each of the arms of the U-shaped spreader bar to generally form an H-shape. Portions of the spreader bar and arms including structural coining reduce racking and prevent bending of the spreader mechanism by adding stiffness to the parts. The pivoting connection between each arm and member is covered by a channel center bracket, with the three parts sharing a common pivot point to provide strength, stiffness, and finger protection. The crossbar connecting the arms of the spreader bar includes a handle for locking/unlocking the spreader. The dimensions of the spreader are designed to allow comfortable access to the handle when the ladder is in the use or closed orientations.

In another embodiment, a handle block is located within a step of one of the stepladder frames to facilitate comfortable movement of the stepladder when in the use position (i.e., open and upright). The handle block is preferably constructed of a durable material and is located in the center of the step to provide balance when moving the stepladder. While a handle block may be located on each step, the preferred embodiment contemplates a single handle block located inside the step that is at a should height or lower of an average person. Preferably the handle block is sized to fill the width of step and provide a level surface on the bottom of the step for user comfort. It is also preferable for strength that the handle block fill the depth of the step for strength. It is also desirable to have the exposed surface of the handling block with ridges or other means of improving grip and comfort for a user.

A further embodiment includes an ergonomic rail handle located within at least one of the rails to facilitate carrying of the ladder is a closed orientation (i.e., folded and horizontal). The rail handle preferably abuts the exterior-facing flange of the rail and does not extend beyond the width of the rail flange so as to not interfere with climbing the stepladder. The preferred embodiment has the rail handle located at the center of gravity for the stepladder in a closed, horizontal position. The rail handle preferably has a curved, indented surface to improve grip of a user's finger for carrying.

An additional embodiment of the stepladder consists of rails that have recesses in the exterior web and flange surfaces (i.e., the edges and corners of the rails are thicker than the rest of the web and flanges). This serves to lessen the weight of the rails while providing requisite load bearing and durability for the rails. The recesses also allow for rivet heads to be recessed, which protects rivets and prevent snagging of items on the rivets. The recesses also provide areas on the exterior web and flange surfaces to protect labels from scuffing.

Another embodiment of the stepladder includes a ladder top cap with a recessed portion on a member under the top cap extending between a pair of rails into which a logo plate may be inserted. In the preferred embodiment, the recess on the protection is deeper than the logo plate and connecting means (e.g., rivets). This embodiment allows for differing logo plates to be used with a top cap used for varying models of stepladders.

A further embodiment includes an improved magnetic keeper within the top cap. A niche within the top cap is sized to allow a flat magnetic plate to be inserted and then covered with preferably a thin cover plate. Preferably, the thin cover plate is metal to allow the magnetic force of the magnetic plate to attract metal objects placed on the cover plate. This allows for a magnetic surface to hold metallic hardware and tools on the top cap. The preferred embodiment includes tabs on the thin cover plate that mate with slots in the top cap to hold the cover plate (and the magnetic plate) onto the top cap. This arrangement also allows for easy removal of the cover plate if the magnetic plate needs to be replaced due to loss of magnetism.

The design also incorporates a deep ladder tray that is mountable to the top cap during use and may be stored on a rail within the perimeter of the rails as disclosed in U.S. patent application Ser. No. 16/788,655, incorporated herein by reference in its entirety.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

FIG. 1 is a front elevation view of a stepladder in an open orientation according to an embodiment of the present invention.

FIG. 2 is a rear elevation view of the stepladder of FIG. 1.

FIG. 3 is a left side elevation view of the stepladder of FIG. 1.

FIG. 4 is a right side elevation view of the stepladder of FIG. 1.

FIG. 5 is a top plan view of the stepladder of FIG. 1.

FIG. 6 is a bottom plan view of the stepladder of FIG. 1.

FIG. 7 is a front elevation close-up view of the top cap of the stepladder of FIG. 1.

FIG. 8 is a top plan close-up view of the top cap of the stepladder of FIG. 1.

FIG. 9 is a left side close-up elevation view of the cap of the stepladder of FIG. 1.

FIG. 10 is an exploded front perspective view of the top cap of the stepladder of FIG. 1.

FIG. 11 is an exploded front perspective view of the logo plate, magnetic plate, and cover plate of the top cap of the stepladder of FIG. 1.

FIG. 12 is bottom plan close-up view of handle block of the stepladder of FIG. 1.

FIG. 13 is a cross-sectional view taken along the line B-B in FIG. 12.

FIG. 14 is a front perspective view taken along the line B - B in FIG. 12.

FIG. 15 is an exploded bottom perspective view of the handle block and step of the stepladder of FIG. 1.

FIG. 16 is a cross-sectional view taken along the line A-A in FIG. 1.

FIG. 17 is a detail view of the rail handle of the stepladder of FIG. 16.

FIG. 18 is top right perspective view of the rail handle of FIG. 17.

FIG. 19 is a left elevation view of the rail handle of FIG. 17.

FIG. 20 is a right elevation view of the rail handle of FIG. 17.

FIG. 21 is front elevation view of the rail handle of FIG. 17.

FIG. 22 is a rear elevation view of the rail handle of FIG. 17.

FIG. 23 is a top plan view of the rail handle of FIG. 17

FIG. 24 is bottom plan view of the rail handle of FIG. 17.

FIG. 25 is a cross-sectional view taken along line C - C in FIG. 21.

FIG. 26 is a front perspective view of the spreader mechanism of the stepladder of FIG. 1.

FIG. 27 is an exploded front perspective view of the spreader mechanism of the stepladder of FIG. 1.

FIG. 28 is a front elevation view of the spreader mechanism of FIG. 26.

FIG. 29 is a rear elevation view of the spreader mechanism of FIG. 26.

FIG. 30 is a left side elevation view of the spreader mechanism of FIG. 26.

FIG. 31 is a right side elevation view of the spreader mechanism of FIG. 26.

FIG. 32 is a top plan view of the spreader mechanism of FIG. 26.

FIG. 33 is a bottom plan view of the spreader mechanism of FIG. 26.

FIG. 34 is a perspective view of the front rail of the stepladder of FIG. 1.

FIG. 35 is a cross-sectional view of the front rail of the stepladder of FIG. 1.

FIG. 36 is a detail view of portion of the rear rail indicated by D-D in FIG. 35.

FIG. 37 is a perspective view of the rear rail of the stepladder of FIG. 1.

FIG. 38 is a cross-sectional view of the rear rail of the stepladder of FIG. 1.

FIG. 39 is a detail view of portion of the rear rail indicated by E-E in FIG. 38.

FIG. 40 is a front perspective view of an alternate embodiment of the spreader mechanism of the stepladder of FIG. 1.

FIG. 41 is a front perspective view of the handle of the alternate embodiment of the spreader mechanism of the stepladder of FIG. 40.

FIG. 42 is a front elevation view of the handle of the alternate embodiment of the spreader mechanism of the stepladder of FIG. 40.

FIG. 43 is a top plan view of the handle of the alternate embodiment of the spreader mechanism of the stepladder of FIG. 40.

FIG. 44 is a rear elevation view of the handle of the alternate embodiment of the spreader mechanism of the stepladder of FIG. 40.

FIG. 45 is a bottom plan view of the handle of the alternate embodiment of the spreader mechanism of the stepladder of FIG. 40.

FIG. 46 is an exploded front perspective view of the handle of the alternate embodiment of the spreader mechanism of the stepladder of FIG. 40.

While the various embodiments of the invention are amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the inventions as may be claimed.

### DETAILED DESCRIPTION OF THE PREFERRED EMBODIMENTS

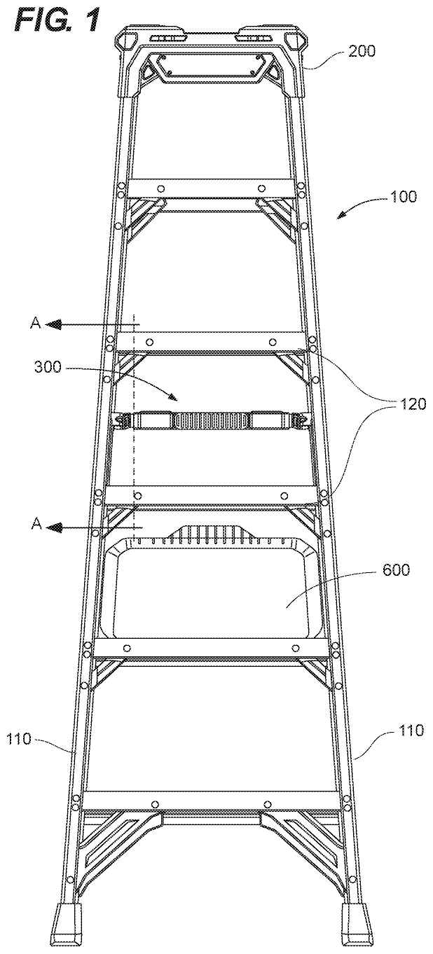

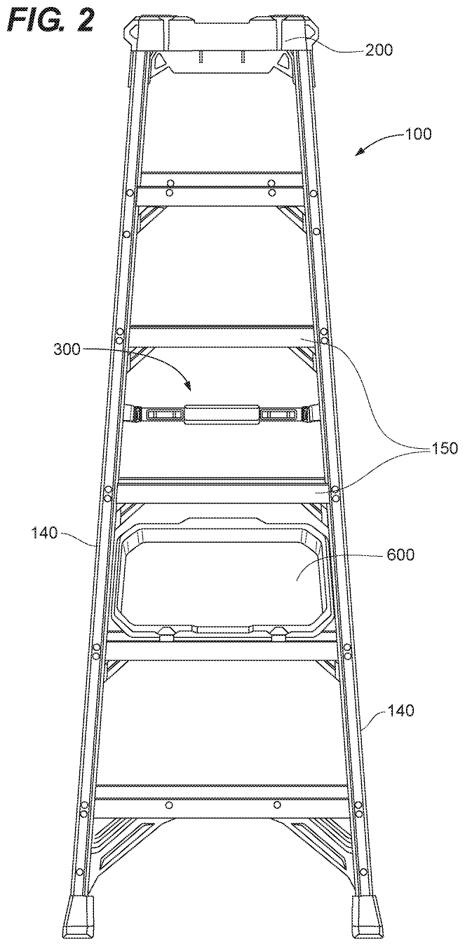

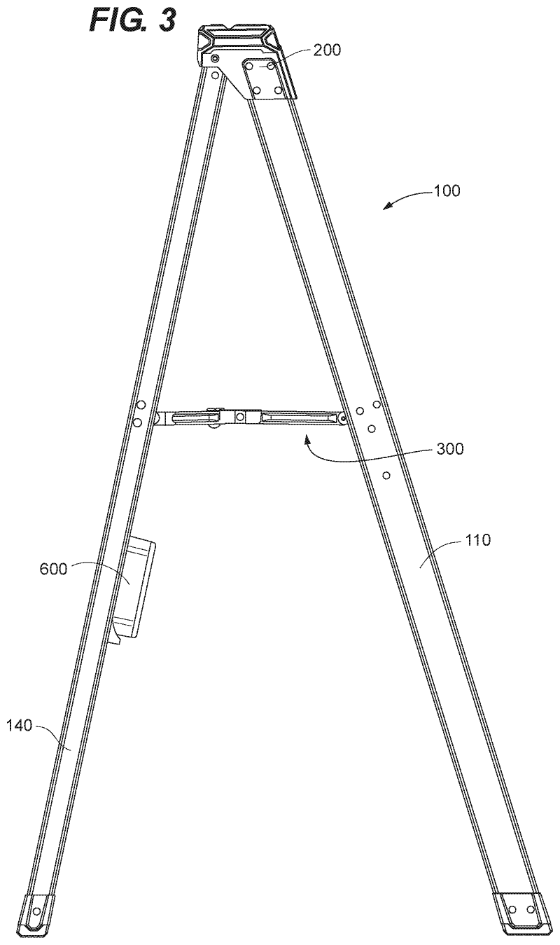

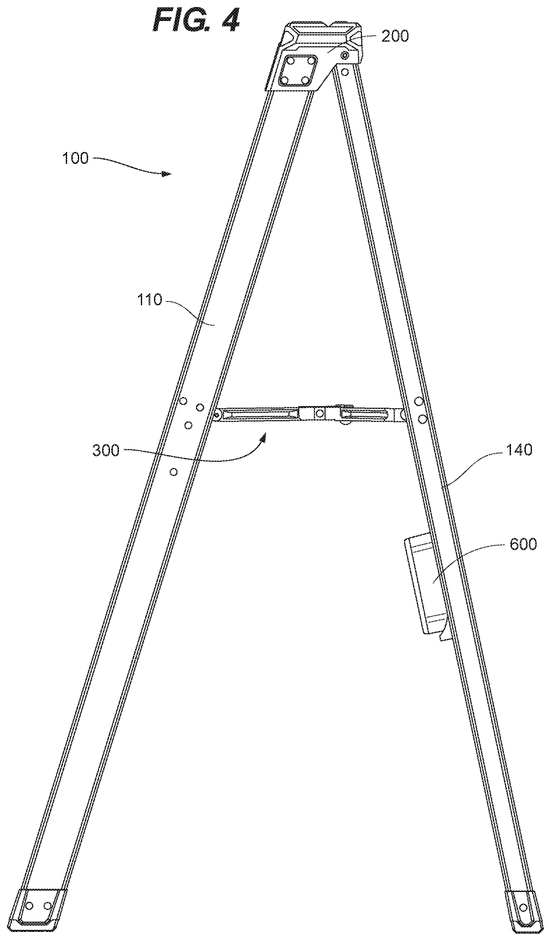

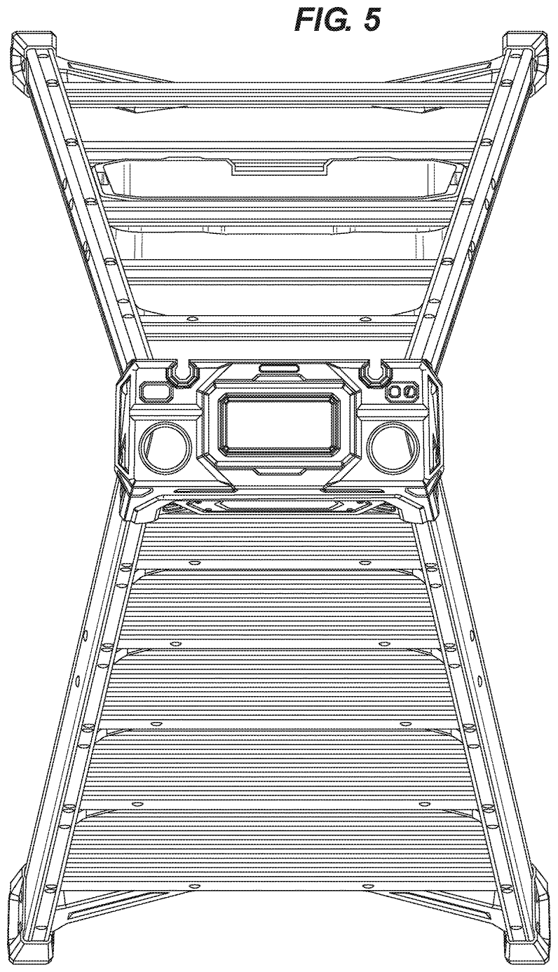

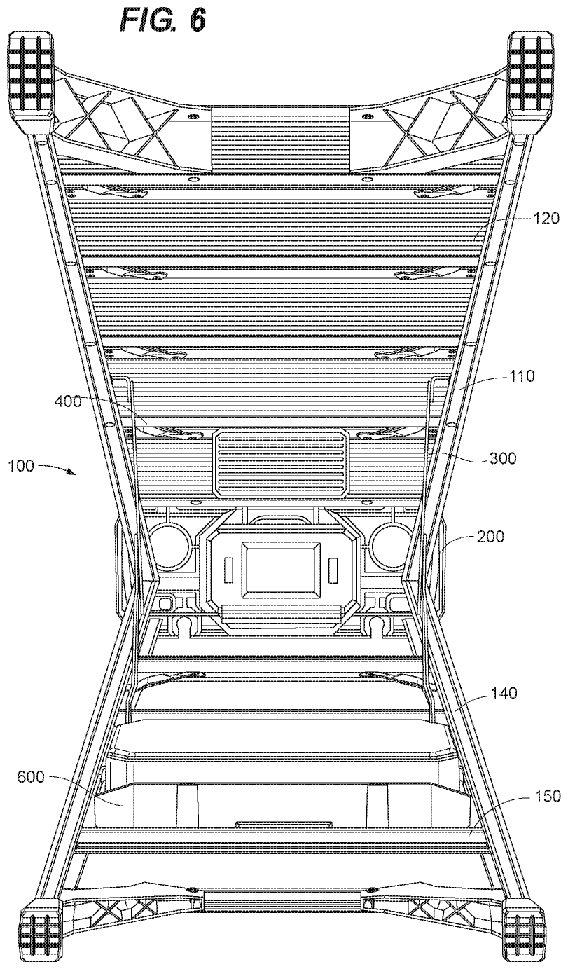

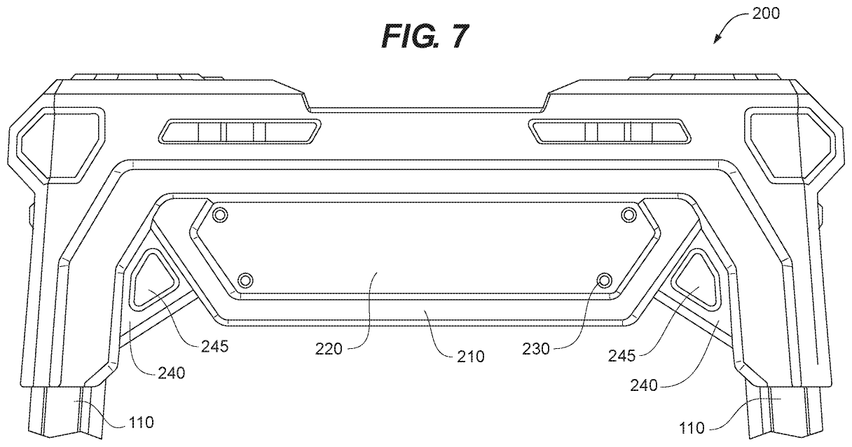

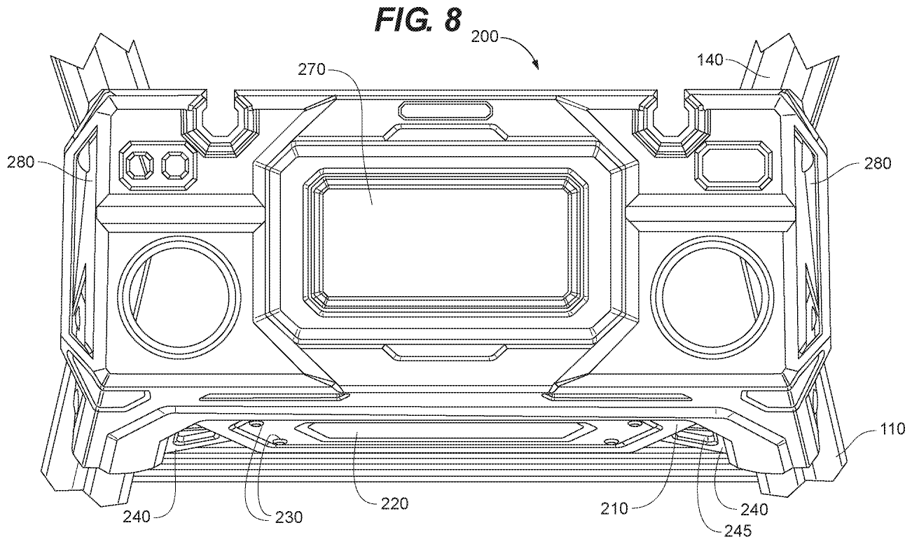

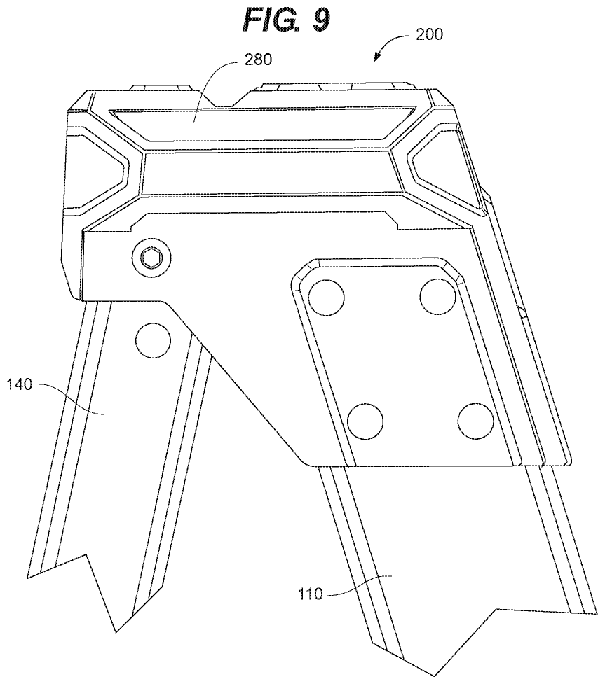

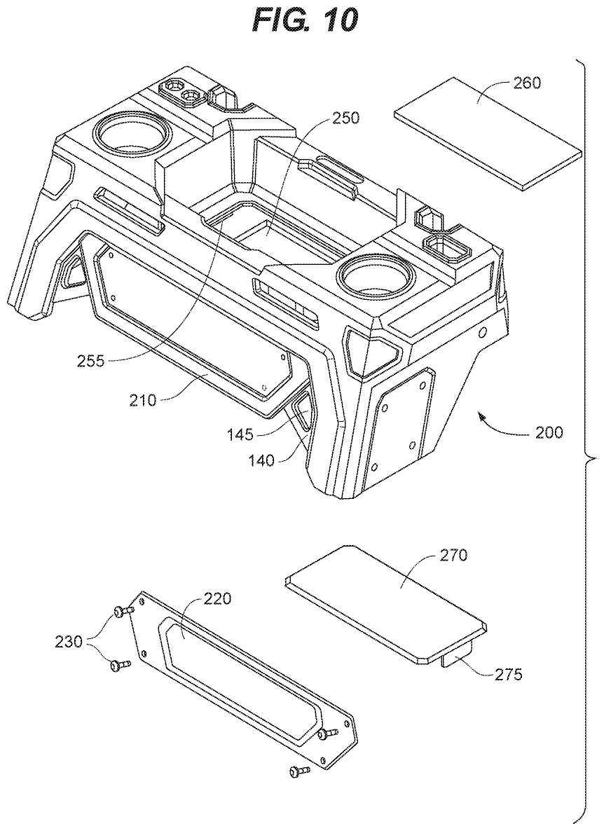

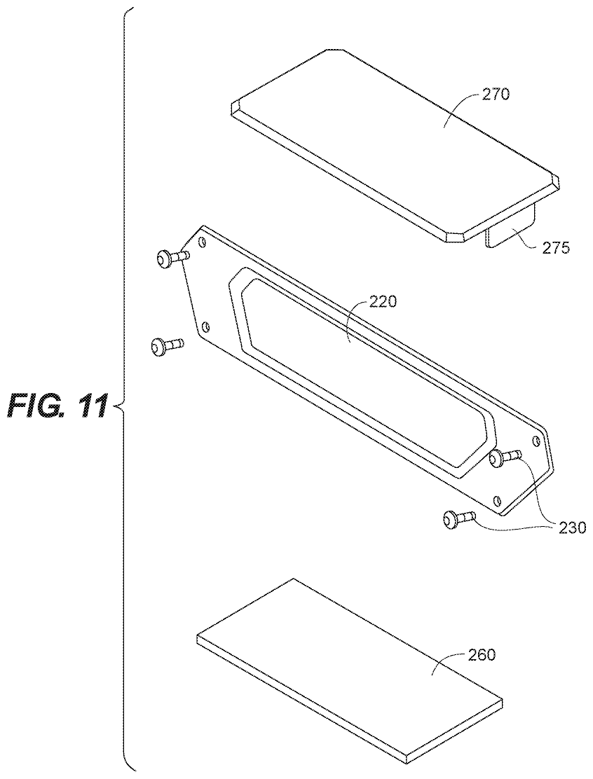

The present invention is a stepladder, as most clearly illustrated at 100 in FIG. 1-6. The stepladder 100 includes a pair of front rails 110 spanned by a series of front steps 120 and a pair of rear rails 140 spanned by a series of rear rail rungs 150. The pairs of front or rear rails 110, 140 are attached to a top cap 200. To allow the stepladder 100 to be closed, one or both pairs of the front and rear rails 110, 140 are pivotably attached to the top cap 200.

The top cap 200 is similar to that disclosed in U.S. patent application Ser. No. 16/788,6551 (incorporated herein by reference), but has additional features. The top cap 200 is designed to receive a tray 600 that can be mounted to the top cap 200 during use or may be stored the front rail 110 or rear rail 120 of the stepladder 100 when not in use. Improvements to the top cap 200 include a mounting member 210 that extends from the front (or rear) surface of the top cap 200 onto which a name plate 220 may be attached by plate mounting member rivets 230. The name plate 220 can be used for branding, model numbers, or any other purpose. This feature allows for the same top cap 200 to be used on various models of stepladders 100 without having to make special molds to change brand, model, or other information. The mounting member 210 is designed so as to not interfere with a user climbing or using the stepladder 100.

Another improvement disclosed by the present invention is the inclusion of hanging members 240 that extend between the top cap 200 and the mounting member 210. The hanging members 240 have an orifice 245 that allow the hanging of tools or equipment from the top cap 200. In the preferred embodiment, the orifice 245 has a low point nearest the nearest front rail 120 to facilitate anything hanging to move toward the rail 120 and prevent interference with using the stepladder 100.

The top cap 200 of the present invention further includes an improved means of retaining metal items and a means of manufacturing the retaining means. It is common for a user of a stepladder 100 to need a place to store or hold metal tools or hardware. Some stepladders 100 have magnets attached to them for this purpose. In most cases the magnets are relatively small, attached poorly using an adhesive, or are exposed and subject to being knocked from the stepladder 100. The present invention includes a magnet recess 250 within the top cap 200 into which a magnet 260 is housed. It is preferable that the recess 250 and magnet 260 be sized to provide a relatively large surface area in the top cap 200 exposed for holding metal pieces. The recess 250 is deep enough that the magnet 260 sits completely inside the recess 250 to prevent accidental dislodging of the magnet 260. The present invention also includes a thin magnet cover 270 to hold the magnet 260 in place without the need for adhesive. The magnet cover 270 is preferably made of metal to allow for better magnetic force available for article retention. In the preferred embodiment the magnet cover 270 includes tabs 275 that pass through a cover slot 255 in the top cap 200 and can be bent to hold the cover onto the top cap 200. Or the tabs 275 may be bent and attached to the top cap 200 via screws, adhesive, or other means known in the art. The top cap 200 also preferably includes ladder tray hooks 280 as disclosed in U.S. Pat. No. D833,643 to Foley et al. and incorporated herein by reference.

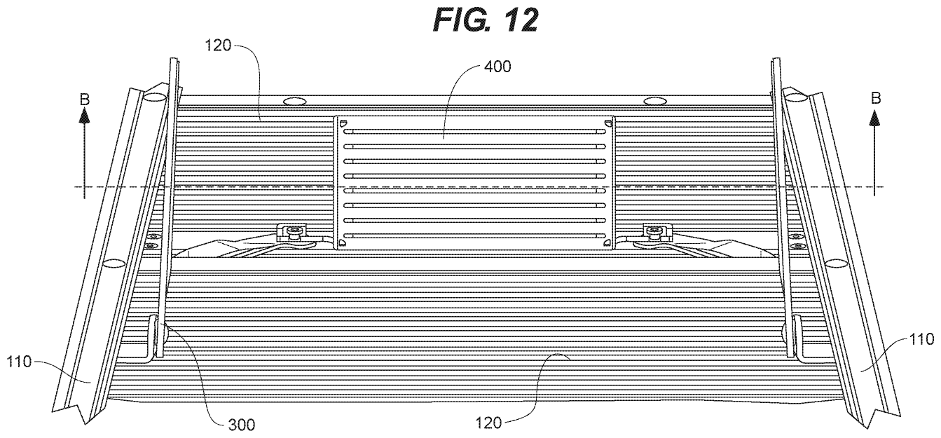

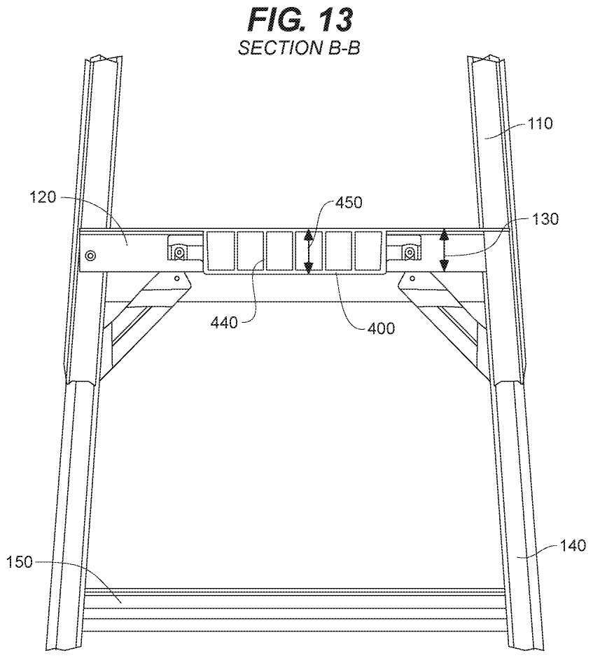

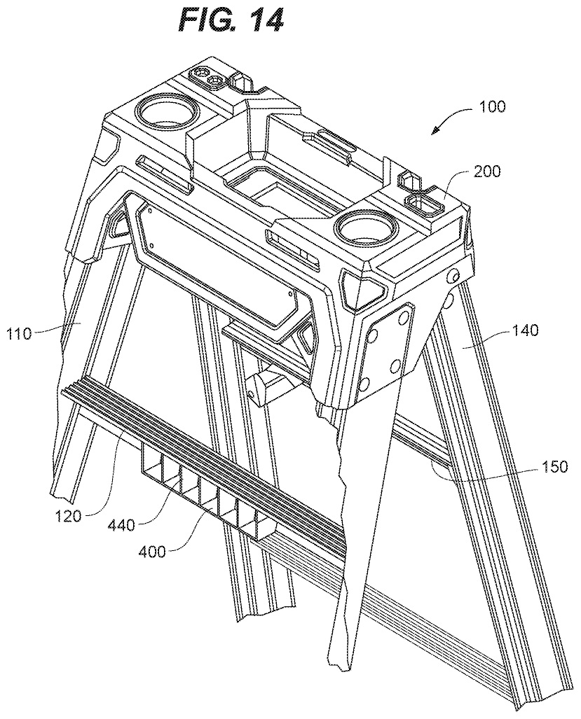

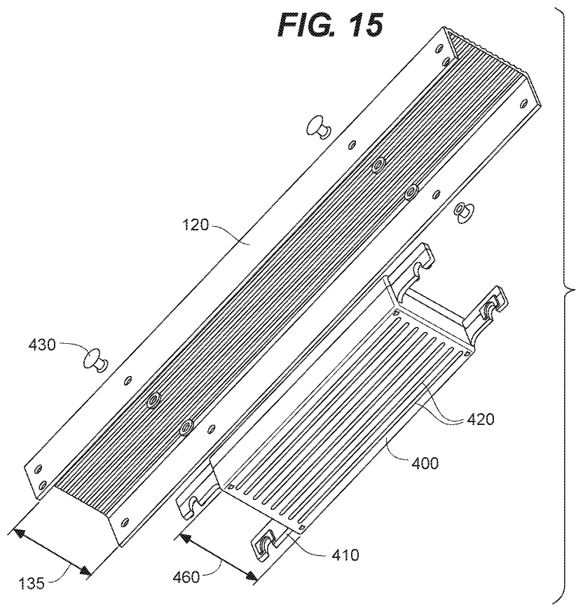

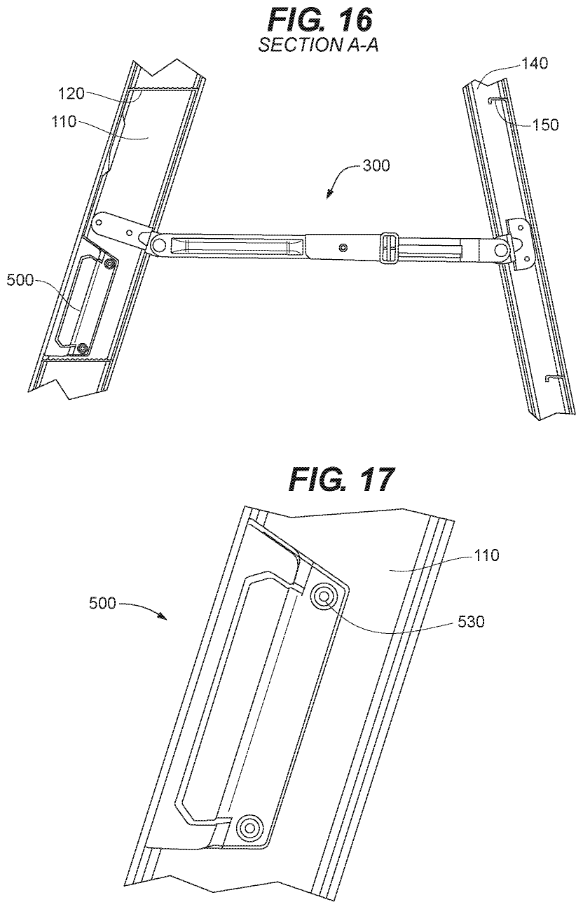

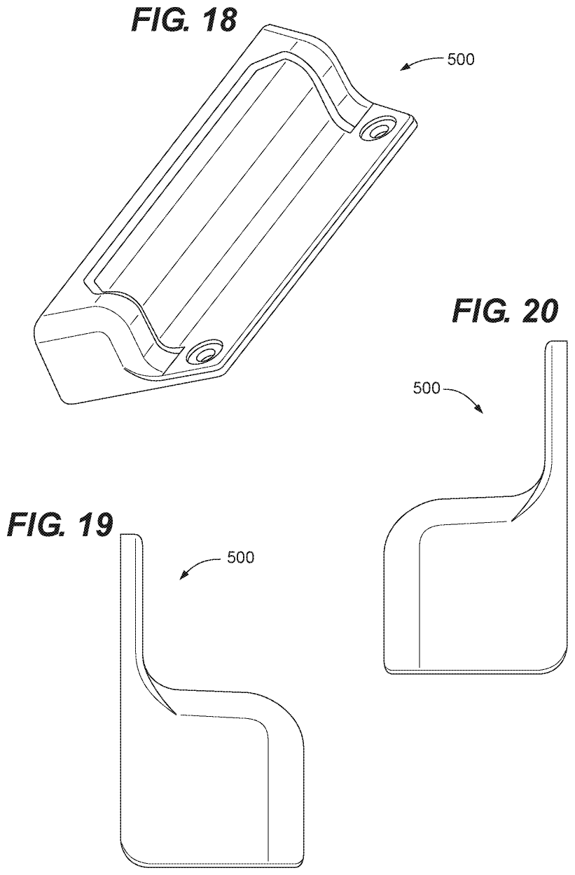

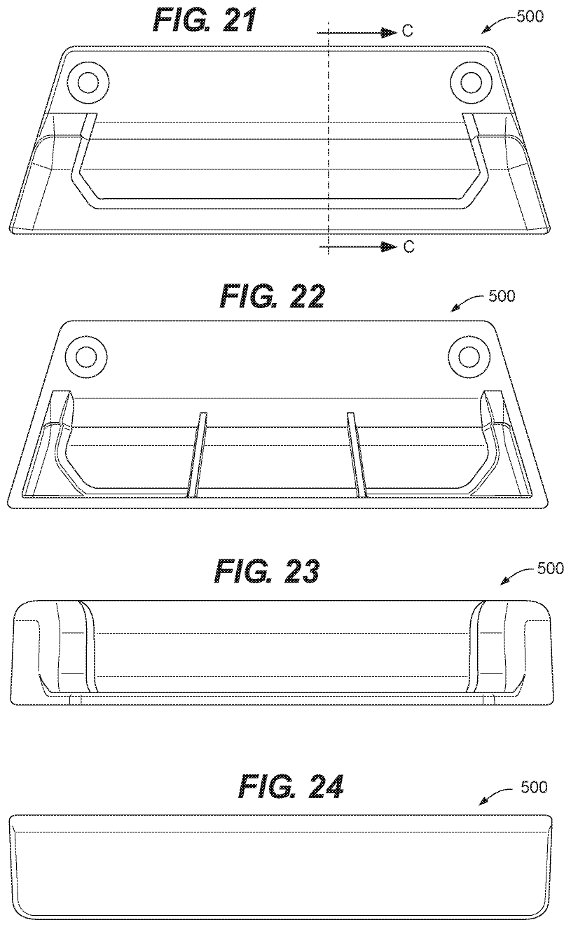

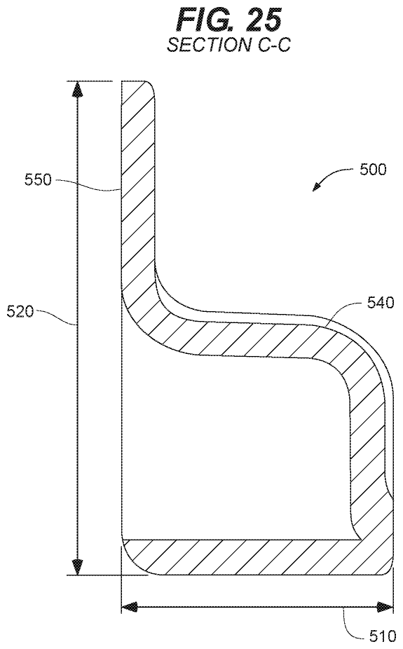

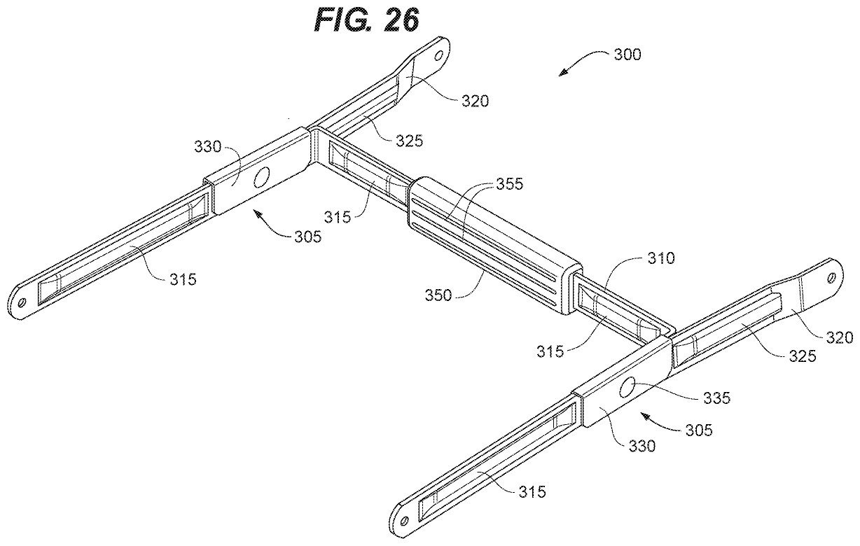

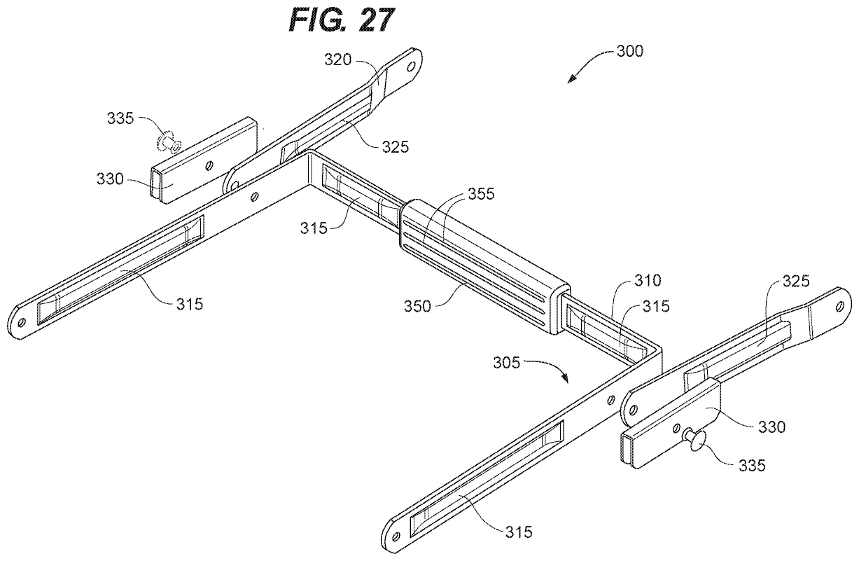

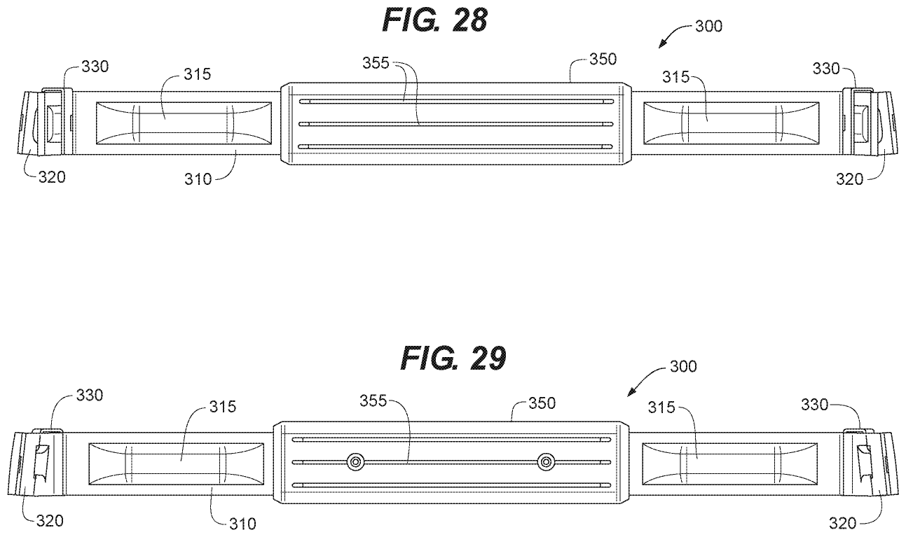

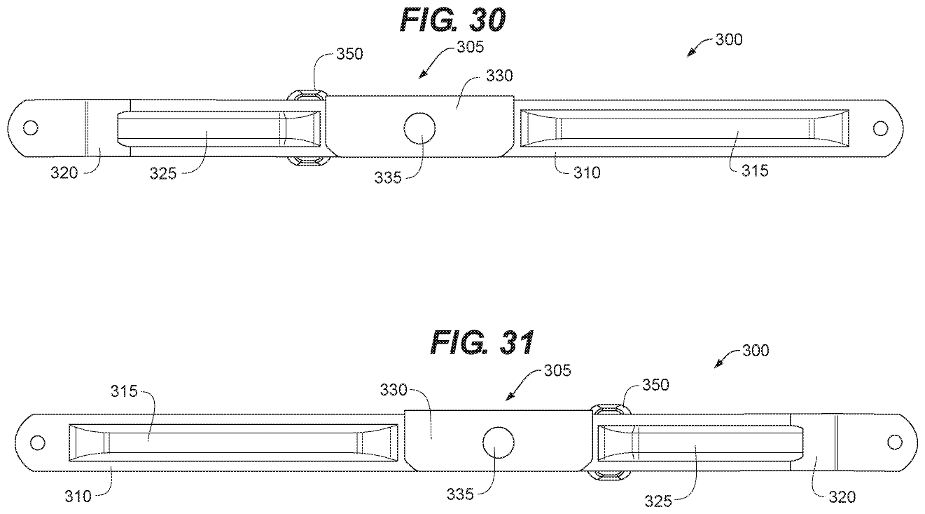

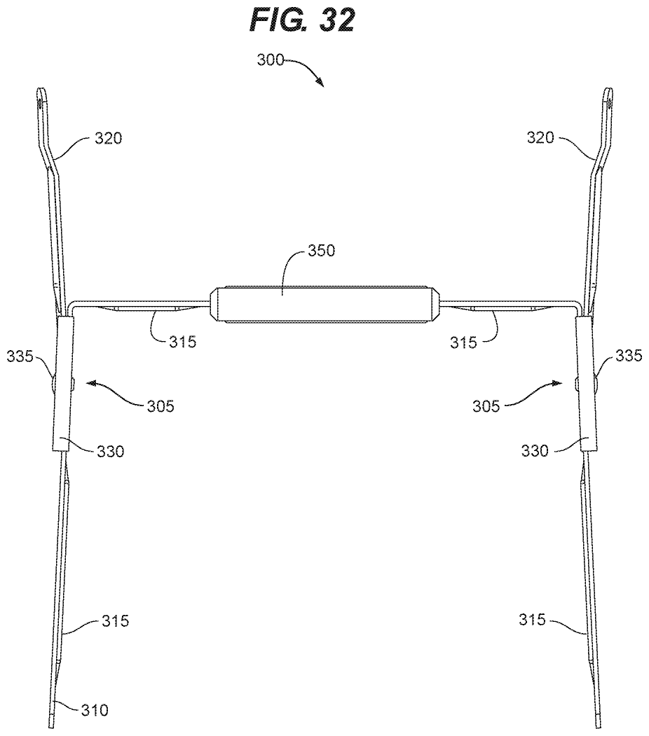

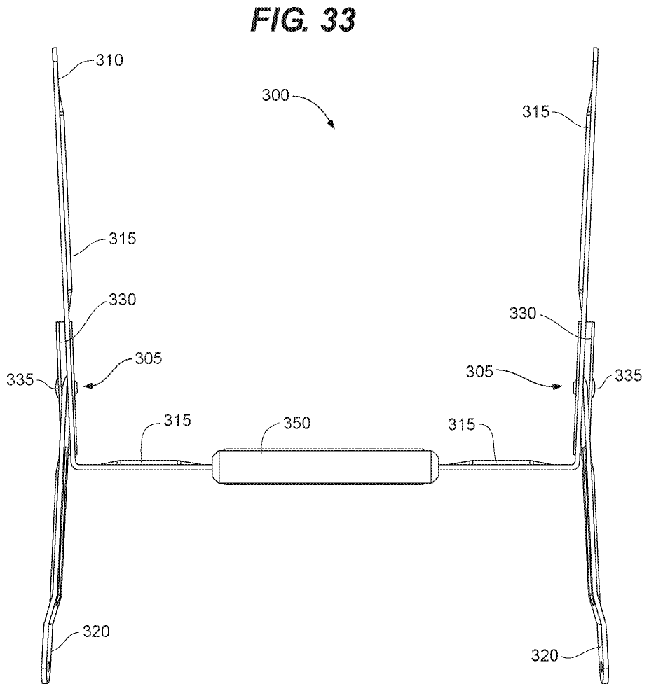

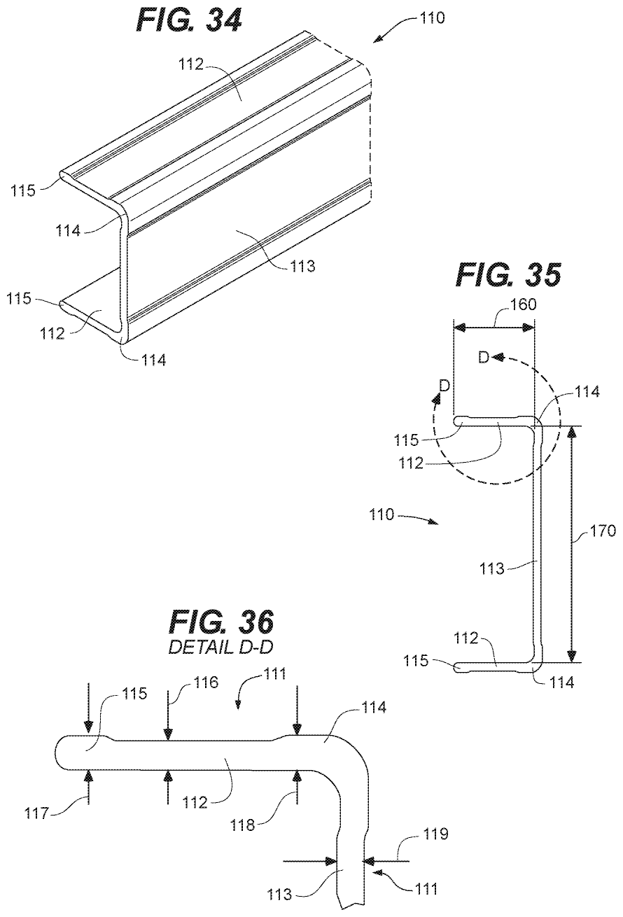

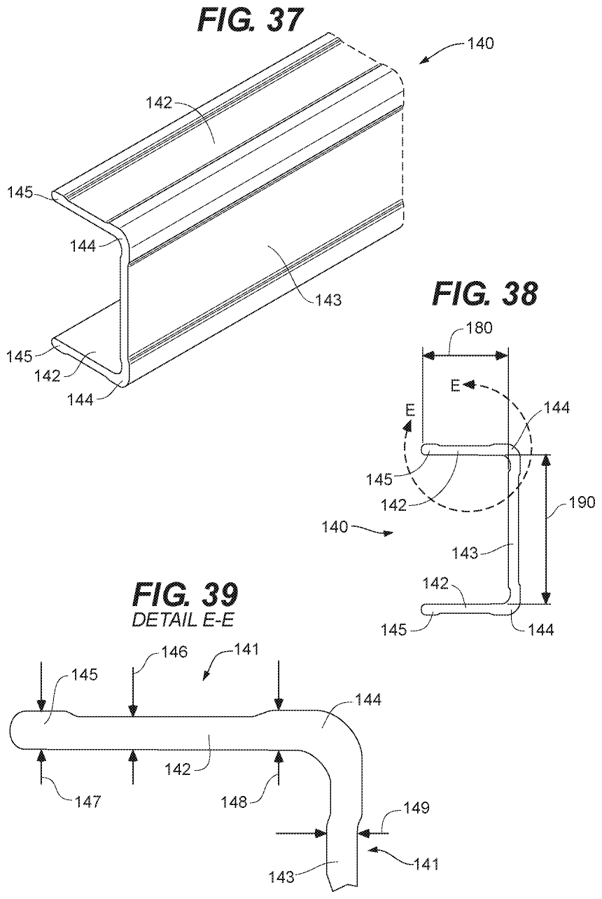

Another improvement disclosed by the present invention and shown in detail by FIGS. 12-15 is the addition of a handle block 400 that is attached to the inside of a front step 120 of the stepladder. The handle block 400 is designed to fit snuggly within the step 120 and provide a surface for a user of the stepladder 100 to move conveniently and comfortably move the stepladder 100 when it is in the open position. To maximize the utility of the handle block 400, it is preferably mounted to an upper step 120 so as to allow an average adult to lift the stepladder 100 by grasping the block 600 while standing. The handle block 600 includes ridges 420 to improve grip of the block 400. While the block 400 can be mounted by any means known in the art, the block preferably has arms 410 that can be attached to the step 120 by rivets 430. The arms 410 preferably extend beyond the gripping surface of the handle block 400 while allowing the block 400 gripping surface to fit between braces on the stepladder 100. The handle block 400 has a height 450 that allows the block 400 to preferably fill the entire interior depth 130 of the step 120 and a width 460 to fill the interior width 135 of the step 120. This arrangement will provide better strength and stability for the handle block 400 as well as provide the optimal comfort for a user of the stepladder 100. To increase strength of the handle block 400 while minimizing weight, the interior of the handle block 400 is preferably mostly void with ribs 440. The handle block 400 may be made of any material known in the art, but is preferably a form of plastic or aluminum that is easily formed, light weight, and has adequate strength and durability for the intended purpose.

A further aspect of the present invention is the use of a lightweight, strong durable and comfortable rail handle 500. The rail handle 500 is preferable located at the center of mass of the stepladder 100 when it is in the closed position. The rail handle 500 is preferably formed of a plastic material that provides necessary strength and durability while also being comfortable for a user to carry the stepladder 100, but may be made of any material known in the art. The preferred method of attaching the rail handle 500 to the stepladder 100 is by rivets 530, but may done by any method known in the art such as adhesive, bolts, or screws. The width 510 of the rail handle 500 is preferably equal to or just less than the front rail width 160 to provide ergonomic comfort. The depth 520 of the rail handle 500 is less than the front rail depth 170 and, preferably, sized to fit the hand of an average adult's fingers. To provide better grip and comfort, the rail handle 500 preferably has an inset 540 of a few millimeters depth. The rail handle rear wall 550 is preferably planar to allow it to abut the interior of the front rail 110, which is also preferably planar. While the preferred embodiment is to have the rail handle 500 mounted to the front rails 110 because they are usually wider (and thus heavier) than the rear rails 120, it is also contemplated that the rail handle 500 may be mounted to the rear rails 120.

An additional feature of the present invention is the novel spreader mechanism 300 that facilitates opening and closing the stepladder 100. The preferred embodiment of the spreader mechanism 300 has a C-shaped spreader bar 310 that is pivotally connected to two spreader members 320. The spreader mechanism 300 is pivotally attached to the front rails 110 and rear rails 120 to not only open and close the stepladder 100, but to for a locked orientation when the stepladder is in the fully open position. The preferred embodiment includes a spreader handle 350 that allows a user to comfortably grasp and either pull or push the spreader mechanism 300 to close or open the stepladder 100. The spreader handle 350 can be made of any material known in the art, but is preferably a firm rubber or plastic and includes ribs 355 to improve grip of the handle 350. The preferred embodiment contemplates spreader members 320 are connected to the spreader bar 310 by rivets 335. To strengthen the spreader mechanism 300 as a whole and provide protection against pinch points, center brackets 330 cover the pivot locations and are attached with the rivets 335 that hold the spreader members to the spreader bar 310. The center brackets 330 are dimensioned to have an interior width to accommodate the thickness of both the spreader bar 310 and a spreader member 320. To improve the strength of the spreader mechanism 300, coining 315, 325 may be used on the spreader bar 310 and spreader members 320, respectively. Preferably the coining 315, 325 does not extend into areas of the spreader bar 310 or spreader members 320 that would interfere with the pivoting of those parts (e.g., under the center brackets 330).

An additional embodiment of the stepladder 100 consists of rails 110, 120 that have insets 111, 141 in the exterior web 113, 143 and flange 112, 142 surfaces (i.e., the edges and corners of the rails are thicker than the rest of the web 113, 143 and flanges 112, 142). This serves to lessen the weight of the rails 110, 140 while providing requisite load bearing and durability for the rails 110, 140. The insets 111, 141 also allow for rivet heads to be recessed, which protects rivets and prevent snagging of items on the rivets. The recesses also provide areas on the exterior web 113, 143 and flange 112, 142 surfaces to protect labels from scuffing. This arrangement also provides strength to vital parts of the rails 110, 140 at the front rail flange ends 115 and corners 114 and at the rear rail flange ends 145 and corners 144. This arrangement is accomplished by having the front rail flange end thickness 117 and corner thickness 118 to be wider than the flange thickness 116 and web thickness 119. The same may be for the rear rail flange end thickness 147 and corner thickness 148 to be wider than the flange thickness 146 and web thickness 149.

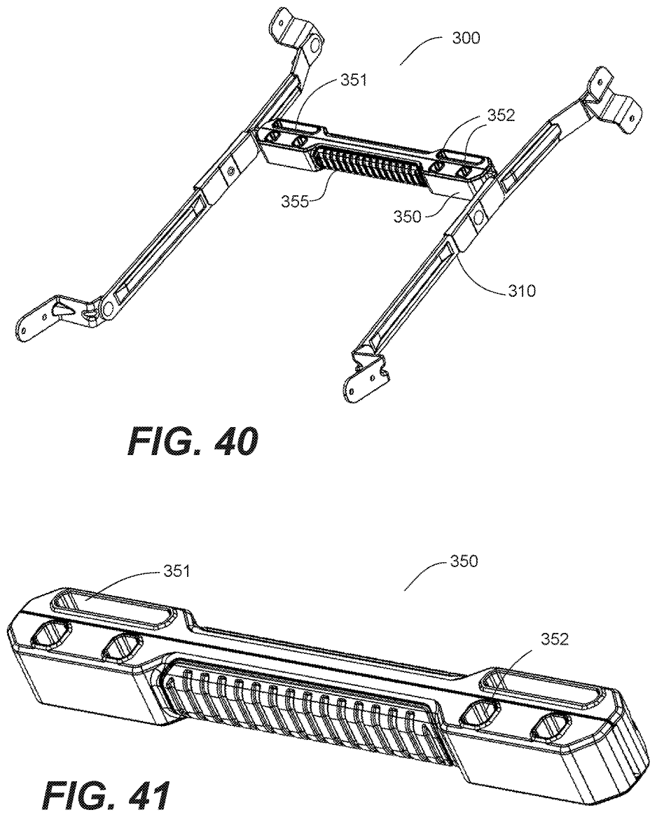

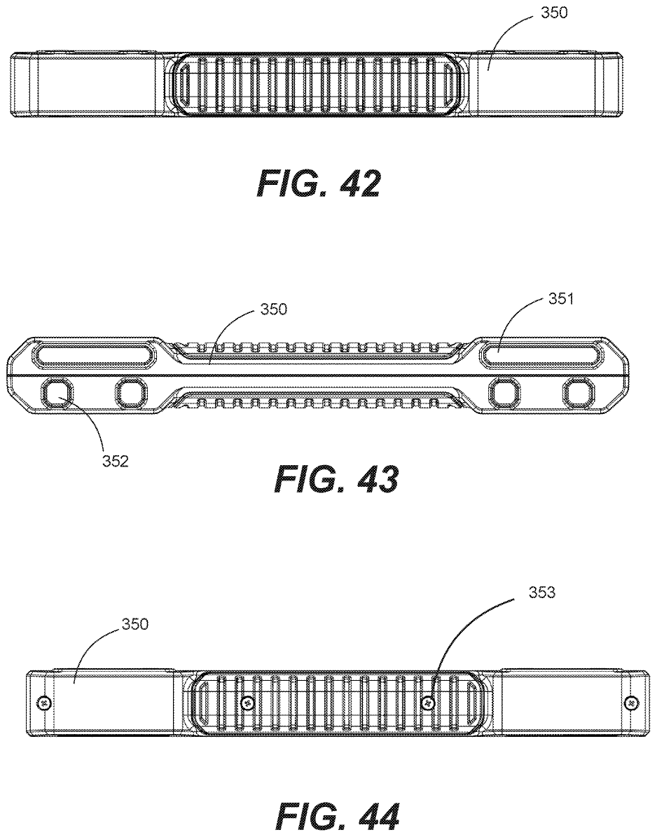

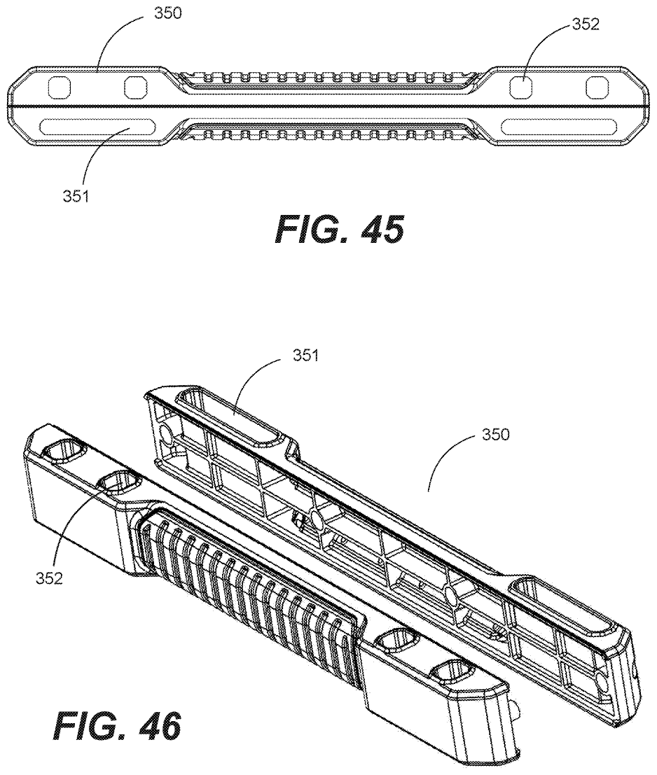

An alternate embodiment of the handle 350 of the present invention is shown in FIGS. 40-46. In this embodiment, the handle 350 includes tool slots 351 and tool orifices 352 onto which tools or other materials may be hung during uses of the stepladder 100. The handle 350 is preferably two halves that sandwich the spreader member 320 and are joined by means such as screws 353 that also run through the spreader member 320 to ensure the handle 350 stays on the spreader bar 320 when stressed from activating the spreader mechanism 350 or from hanging tools from the handle 350.

It is contemplated that features disclosed in this application, as well as those described in the above applications incorporated by reference, can be mixed and matched to suit particular circumstances. Various other modifications and changes will be apparent to those of ordinary skill.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

We claim:

1. A folding stepladder comprising:
a pair of front rails connected by a step;
a pair of rear rails connected by a cross brace;
a top cap connected to at least one of the pair of front rails or the pair of rear rails;
a spreader mechanism comprising:
a C-shaped spreader bar operably connected to each of the pair of front rails;
a pair of hinges, each hinge pivotally connected to the spreader bar and comprising:
a spreader member pivotally connected to a respective rear rail; and
a center bracket having a shared pivot point with the spreader member and the spreader bar; and
a handle affixed to the spreader bar, the spreader bar comprising a tool orifice.

2. The folding stepladder of claim 1 wherein the handle comprises a grip.

3. The folding stepladder of claim 2 wherein the handle comprises two parts.

4. The folding stepladder of claim 3 wherein each handle part comprises a tool orifice.

5. The folding stepladder of claim 3 wherein each handle part comprises a grip.

6. The folding stepladder of claim 4 wherein C-shaped spreader bar is sandwiched between the two handle parts.

7. The folding stepladder of claim 6 comprising a means for affixing the two handle parts to the C-shaped spreader bar and the means for affixing traverses the C-shaped spreader bar.

8. The folding stepladder of claim 7 wherein the handle comprises a length and wherein the spreader bar is completely enclosed within the handle along the entirety its length.

9. The folding stepladder of claim 7 wherein the means for affixing the two handle parts is a self-tapping screw.

10. The folding stepladder of claim 7 wherein the means for affixing the two handle parts is a rivet.

11. The folding stepladder of claim 5 wherein each handle part comprises a tool orifice on either side of the grip.

12. A folding stepladder comprising:
a pair of front rails connected by a step;
a pair of rear rails connected by a cross brace;
wherein at least one of the pair of front rails and pair of rear rails is pivotally connected a top cap;
a spreader mechanism comprising:
a spreader bar operably connected to each of the pair of front rails;
a pair of hinges, each hinge pivotally connected to the spreader bar and comprising:
a spreader member pivotally connected to a respective rear rail; and
a handle affixed to the spreader bar, the spreader bar comprising a tool orifice.

13. The folding stepladder of claim 12 wherein the handle comprises two parts.

14. The folding stepladder of claim 13 wherein each of the two handle parts comprises a tool orifice.

15. The folding stepladder of claim 14 wherein each of the two handle parts comprises a grip.

16. The folding stepladder of claim 15 wherein the spreader bar is sandwiched between the two handle parts.

17. The folding stepladder of claim 16 wherein the two handle parts are affixed to the spreader bar by a screw that traverses the spreader bar.

18. A spreader mechanism for a ladder comprising:
a C-shaped spreader bar;
a pair of arms, each arm pivotally connected to the spreader bar;
a handle affixed to the spreader bar, the handle comprising a tool orifice.

19. The spreader mechanism for a ladder of claim 18 wherein the spreader bar comprises a grip.

20. The spreader mechanism of claim 19 wherein the handle comprises a tool orifice on the inside of the spreader bar and a tool orifice on the outside of the spreader bar.
